(19) United States
(12) Patent Application Publication
(10) Pub. No.: US 2010/0218904 A1
(43) Pub. Date: Sep. 2, 2010

(54) FUNCTIONAL TAG APPLICATOR

(76) Inventor: Toshikazu KAWADA, Tokyo (JP)

Correspondence Address: WENDEROTH, LIND & PONACK, L.L.P., 1030 15th Street, N.W.,, Suite 400 East, Washington, DC, 20005-1503, US

(21) Appl. No.: 12/497,779

(22) Filed: Jul. 6, 2009

(30) Foreign Application Priority Data
Feb. 27, 2009 (JP) 2009-045620

(51) Int. Cl. B32B 37/02

(52) U.S. Cl. 156/538

(57) ABSTRACT

A functional tag applicator permitting stable attachment of functional tags is offered. The applicator includes a tag support mechanism for supporting the peeled functional tag. The tag support mechanism has a sliding member and a pair of left and right functional tag support members. The sliding member slides in an up-and-down direction when a control handle is operated. The tag support members are opened and closed in response to vertical motion of the sliding member. The tag support members have, at their lower ends, support portions for supporting the tag. The tag peeled off from the tape by a peeling member is supplied to the support portions of the functional tag support members. Downward motion of the sliding member spreads apart the tag support members, releasing the tag. Pressure is applied on the upper surface of the tag, so that the tag is stuck.

### BACKGROUND OF THE INVENTION

1. Field of the Invention

The present invention relates to a functional tag applicator of accepting multiple sheet-like labels or tags (hereafter referred to as functional tags), arranging the tags at regular intervals on tape, temporarily holding the tags, peeling the tags one by one while feeding out the tape incrementally, and sticking the tags as labels on products.

Herein, the “functional tag” means a label or tags incorporating some function, which cannot be realized by a label or tag made only from papers. The functional tag includes, for example, an IC tag having an Integrated Circuit Semiconductor chip (IC) therein, which is capable of electronically storing information such as manufacturer of a product, place of production, quality, channel of distribution, and price; a robbery prevention label or tag, and the like.

2. Prior Art

Plural techniques in the form of hand labelers for causing labels on which price and other information are printed to be attached on products are well known in the art. For example, a “label applicator” disclosed in JP-A-2001-106215 has a feed-out mechanism activated by handle action for feeding out tape in a given direction, a pawl mounting member swingably disposed on the front-end side of the body of the applicator, a sensitive pawl swingably mounted to the front end of the pawl mounting member, coming into engagement with the front end of label bonded to a roll of tape when it is fed out, and angularly displacing the pawl mounting member, an adjust-and-stop lever interlocking with the angular displacement of the pawl mounting member, automatically adjusting the length of the portion of the tape fed out by the feed-out mechanism to the adhesion pitch of the label, and stopping motion of the feed-out mechanism, and a disengaging member for disengaging the sensitive pawl from the front end of the label interlockingly with the returning motion of the handle. The sensitive pawl is designed to be slidably displaced at least widthwise of the tape and/or label according to the shape and size of the used label.

The sensitive pawl is slidably displaced at least widthwise of the tape and/or label according to the shape and size of the used label. Consequently, the pawl can be moved so as to be aligned to the widthwise-central position of the label whatever shape and size the label has. Hence, label can be fed out precisely and timely. The label can be stuck reliably.

Furthermore, a “label applicator” disclosed in JP-A-2006-69664 comprises the fundamental structure disclosed in the above-cited JP-A-2001-106215 together with an adjusting mechanism including a limitation portion capable of controlling the amount of returning motion made either by a backing sheet-transporting member or by a manual lever. Where a continuous label stock in which no space is formed between adjacent labels is used, if the limitation portion of the adjusting mechanism is brought to a position located immediately behind the returning motion stop position of the backing sheet-transporting member or manual lever determined in response to arrival of the front end of the next label at the label sensor, and if the label sensor fails to detect the arrival of the front end of the next label, the amount of returning motion of the backing sheet-transporting member or manual lever is limited by the limitation portion of the adjusting mechanism.

Because the amount of returning motion of the backing sheet-transporting member or manual lever is limited by the limitation portion of the adjusting mechanism, if the arrival of the front end of the label should not be detected, it is unlikely that plural labels are peeled off at a time. This prevents jamming of labels; otherwise, troubles would be produced.

However, any of the above-described conventional hand labelers is merely designed so that thin, lightweight, and flexible labels on which prices and other information are printed are stuck on products. These hand labelers do not have capabilities of attaching sheet-like functional tags that are harder and thicker than labels.

That is, a sheet-like functional tag is thicker and heavier than a label. Therefore, there is the problem that when the tag is peeled off from tape incrementally fed out by handle action, the tag will immediately drop from its front-end side by its own weight. Consequently, the tag will not be correctly stuck on the product at the predetermined position.

Furthermore, prior art labels which are thin and lightweight do not come off even if products carrying the labels thereon are moved as long as the labels are placed at predetermined positions. Functional tags are thicker and heavier. If the tags are simply made to rest on products at predetermined positions, sufficient sticking force is not obtained. There is the problem that if the products are moved, the tags peel and come off from the products.

### SUMMARY OF THE INVENTION

Accordingly, it is an object of the present invention to provide a functional tag applicator capable of causing sheet-like functional tags peeled off from tape incrementally fed out by handle action to be stuck at correct positions on products and of applying a some degree of pressing force on the stuck functional tags such that the tags can be stably stuck.

A functional tag applicator according to the present invention has a body frame, a grip integrally formed with the body frame, a control handle mounted in an opposite relation to the grip, a feed-out mechanism for feeding out tape in response to an operation of the control handle, a sensitive pawl for sensing a front end of functional tag stuck and held on the tape, a peeling member for peeling off the functional tag from the tape, and a tag support mechanism for supporting the peeled functional tag. The tag support mechanism has a sliding member sliding in an up-and-down direction in response to an operation of the control handle and left and right functional tag support members of a pair that are opened and dosed in response to vertical motion of the sliding member. Each of the tag support members has a support portion at its lower end. The support portions of the tag support members act to support the functional tag. The functional tag peeled off by the peeling member from the tape fed out by operation of the control handle is supplied to the support portions of the functional tag support members. Downward motion of the sliding member spreads apart the functional tag support members to thereby release the supplied tag. Then, pressure is applied on the upper surface of the functional tag.

Preferably, the support mechanism is surrounded by a box-like outer wall having at least a front-end wall and both sidewalls. The box-like outer wall has a rear end and a bottom end that are open. Upper and lower guide pins of a pair protrude from the inner side surface of the front-end wall. A slit-like guide groove extending in an up-and-down direction is formed in the sliding member. The guide pins are slidably fitted in the guide groove.

Preferably, each of the functional tag support members has an intermediate portion pivotally mounted to a shaft protruding from the inner side surface of the front-end wall. Guide bosses protrude from around the upper ends of the tag support members toward the front-end wall. The sliding member is provided with cam grooves of a pair arranged symmetrically left and right with respect to the center of the sliding member. The grooves are spaced from each other by a space that increases in going downward. The guide bosses are slidably fitted in the cam grooves.

Preferably, a shaft member is rotatably mounted between the sidewalls of the support mechanism. The control handle is connected to one end of the shaft member via a link member. Slit-like cutouts or recessed portions are formed in the arm members, which in turn integrally protrude from a free end of the shaft member. Bosses protrude from both side surfaces of the sliding member, and are engaged in the cutouts. The sliding member is moved up or down by rotating the shaft member through a given angle. At the same time, the functional tag support members are driven to be opened or closed via the guide bosses fitted in the cam grooves formed in the sliding member.

The sliding member is always biased downward by coil springs. Preferably, a shock-absorbing member is mounted at the lower end of the sliding member. The support portions of the functional tag support members can have rectangular cutouts.

The apparatus of the present invention has the sliding member moved up and down by handle action and the pair of functional tag support members that are opened or closed by vertical motion of the sliding member. The support portions are formed in the lower ends of the tag support members. Therefore, a functional tag peeled off from tape via the peeling member is supplied to the support portions of the functional tag support members, the tape being fed out by operation of the control handle. The sliding member is lowered to spread apart the tag support members, thus releasing the supplied tag. At the same time, the hard functional tag can be stuck on a product at a predetermined position by applying pressure on the upper surface of the tag. In this way, excellent advantages can be gained.

The prior art hand labeler structure can be used unchanged in performing a sequence of works starting from feeding of tape and ending with peeling of a functional tag from tape. Consequently, the manufacturing cost can be suppressed.

### BRIEF DESCRIPTION OF THE DRAWINGS

FIG. 1 is a perspective view of a functional tag applicator according to the present invention;

FIG. 2 is a schematic perspective view of main portions of the functional tag applicator,

FIG. 3 is a perspective view taken from the rear side of a tag support mechanism that is a main portion of the functional tag applicator;

FIG. 4 is a rear view of the tag support mechanism, and in which the mechanism is not in operation;

FIG. 5 is a rear view of the tag support mechanism, and in which the mechanism is in operation;

FIG. 6 is a schematic side elevation of a control system for the functional tag applicator; and

FIG. 7 is a perspective view of a part of tape on which commercially available functional tags are stuck and held, the tape being capable of being used with the functional tag applicator.

### DETAILED DESCRIPTION OF THE PREFERRED EMBODIMENTS

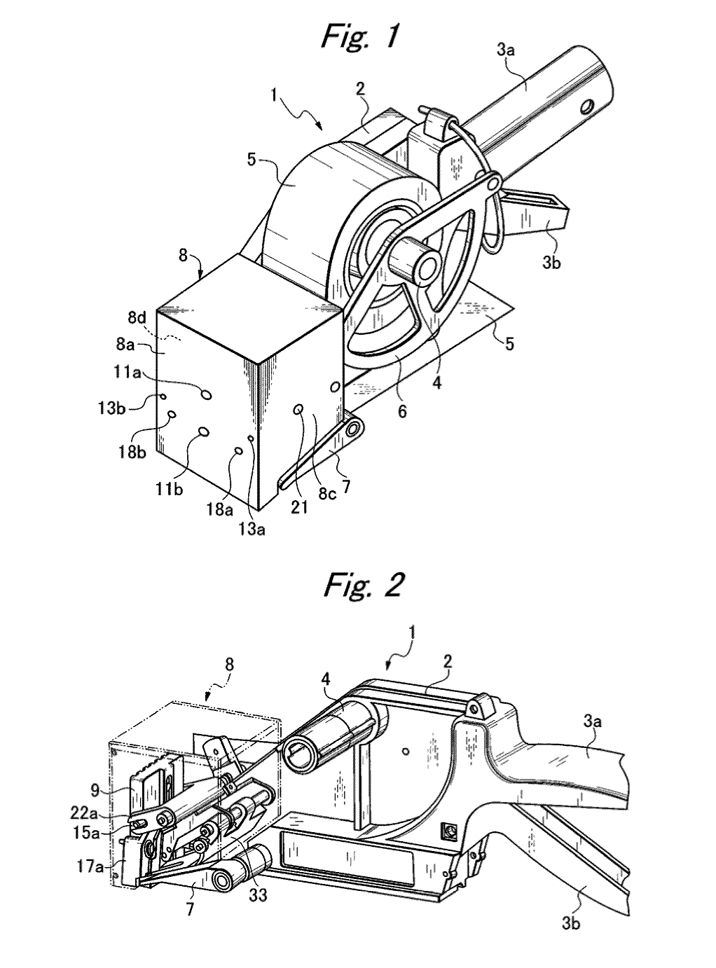

As shown in FIG. 1, a functional tag applicator 1 according to an embodiment of the present invention has a grip 3a and a control handle 3b at the rear end of a body frame 2, in the same way as in the prior art hand labeler. A roll of tape 5 is rotatably disposed on a fixed shaft 4 protruding from a side surface near the midpoint of the body frame 2. A stopper 6 is detachably mounted at the front end of the fixed shaft 4 to prevent the roll of tape 5 from coming off. The tape 5 can be fed out toward the front end by operating the control handle 3b. The fed tape 5 is passed around the front end of a peeling member 7 and fed backwardly toward the rear end. Consequently, functional tags aligned on the tape 5 and stuck on it are peeled off successively, supplied to predetermined positions on products, and stuck there. The functional tag applicator 1 is constructed in this way. Furthermore, a functional tag support mechanism 8 is disposed on the front-end side.

As shown in FIGS. 2 to 5, the tag support mechanism 8 is surrounded by a box-like outer wall having open rear end and lower end. A sliding member 9 that slides in an up-and-down direction is disposed inside a front-end wall 8a of the outer wall. A slit-like guide groove 10 extending in the up-and-down direction is formed in the sliding member 9. Guide pins 11a and 11b of a pair mounted to the front-end wall 8a are fitted in the guide groove 10. The sliding member moves up and down vertically while guided by the guide pins. Note that the present invention is not limited to this structure if any members such as rail-like guide members that permit the sliding member to slide in the vertical direction are adopted.

Pins 12a and 12b are mounted to top portions of both side surfaces of the sliding member 9. Pins 13a and 13b are mounted to the front-end wall 8a. The pins 12a and 13a are connected by a coil spring 14a. Similarly, the pins 12b and 13b are connected by a coil spring 14b. Thus, the sliding member 9 is always biased downward. Bosses 15a and 15b are located near the midpoints of the side surfaces, respectively, and protrude outwardly.

The sliding member 9 is provided with cam grooves 16a and 16b arranged symmetrically left and right with respect to the center of the sliding member. The grooves 16a and 16b are spaced from each other by a space that increases in going downward. A shock-absorbing member 9a made of rubber or the like is mounted to the lower end of the sliding member.

Shafts 18a and 18b protrude from the front-end wall 8a and are located on the outsides of the cam grooves 16a and 16b, respectively. Functional tag support members, 17a and 17b, of a pair are rotatably mounted and arranged symmetrically. The functional tag support members 17a and 17b are pivotally mounted to the shaft 18a and 18b at their intermediate points. Guide bosses 19a and 19b protrude from around the upper ends of the tag support members 17a and 17b, respectively, and are engaged in the cam grooves 16a and 16b, respectively, formed in the sliding member 9. Cutouts 20a and 20b are formed in the lower ends of the support members to support a functional tag. As the sliding member 9 moves up or down, the guide bosses 19a and 19b move up or down along the cam grooves 16a and 16b, thus opening or dosing the cutouts 20a and 20b in the lower ends.

The sliding member 9 is driven to move up and down by a shaft member 21 held between the sidewalls 8b and 8c of the box-like outer wall. That is, arm members 22a and 22b of a pair integrally protrude from the shaft member 21. Slit-like cutouts or recessed portions 22c and 22d are formed on the front-end sides of the arm members. The bosses 15a and 15b are engaged in the cutouts, respectively. The portion of the shaft member 21 on the side of the sidewall 8c protrudes toward the body frame 2. A link member 23 is mounted to the protruding end. A boss 24 protrudes from the front end of the link member 23. A member 25 in the form of a flat plate is disposed on the boss 24 such that the plate-like member 25 is brought into and out of engagement with the boss 24 by piston action. The above structure merely forms one example for moving the sliding member 9 up and down. The invention is not limited to this example. For example, a cam member that can be rotated by a belt, which in turn is driven by handle action, may be engaged to the sliding member. The cam member may be rotated to bring it into and out of engagement with the sliding member, thus moving the sliding member up and down. Furthermore, other structure may also be employed. In summary, any structure may be adopted as long as it can feed out tape in response to a handle action and the sliding member can be moved up and down.

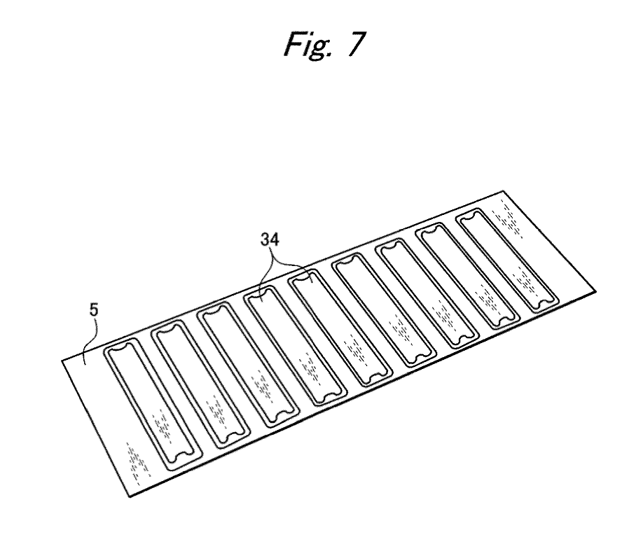

As shown in FIG. 6, the plate-like member 25 has a cutout or recessed portion 25a at its front-end side. The cutout 25a engages the boss 24. A protrusion having a tilted portion 25b is formed at the lower end of the plate-like member. The rear end of the plate-like member is connected to an intermediate portion of a lever member 28 that is disposed swingably relative to the control handle 3b via transmission gears. The control handle 3b has a toothed portion 3c that is in mesh with a sectorial-toothed segment 27 via an intermediate gear 26. The lever member 28 is integrally coupled to the toothed segment 27.

Because of this connection, when the control handle 3b is gripped and the apparatus is driven, the sectorial-toothed segment 27 is rotated via the intermediate gear 26. The lever member 28 coupled to the toothed segment 27 is rotated in the direction of arrow “a”. As a result, the plate-like member 25 is drawn toward the rear end. A guide pin 29 protrudes from the wall surface of the body frame 2. When the plate-like member 25 is pulled toward the rear end, the guide pin 29 comes into abutment with the tilted portion 25b, pushing up the whole plate-like member. At the same time, the cutout 25a is disengaged from the boss 24. A spring 30 is mounted to bias the plate-like member 25 downward at all times.

A feed-out member 31 and a sensitive pawl 32 are mounted. When the control handle 3b is operated and the lever member 28 is rotated in the direction of the arrow “a”, the feed-out member 31 feeds out the tape 5 and the pawl 32 detects a functional tag. There is also provided a tape guide plate 33. The operations of these members for feeding out the tape 5 and for detecting the position of the functional tag assumed before it is peeled off from the tape 5 and their functions are substantially identical with the operations and functions of the hand labeler which has been already described as the prior art and for which a patent has been filed by the present applicant and so their detailed description is omitted. In summary, the apparatus which can successively feed out the labels stuck on the tape when the handle is operated and which can peel off the labels one by one and stick them on products can be applied to the tape 5 on which functional tags 34 are stuck as shown in FIG. 7.

The operation of the functional tag applicator 1 according to the present invention is next described.

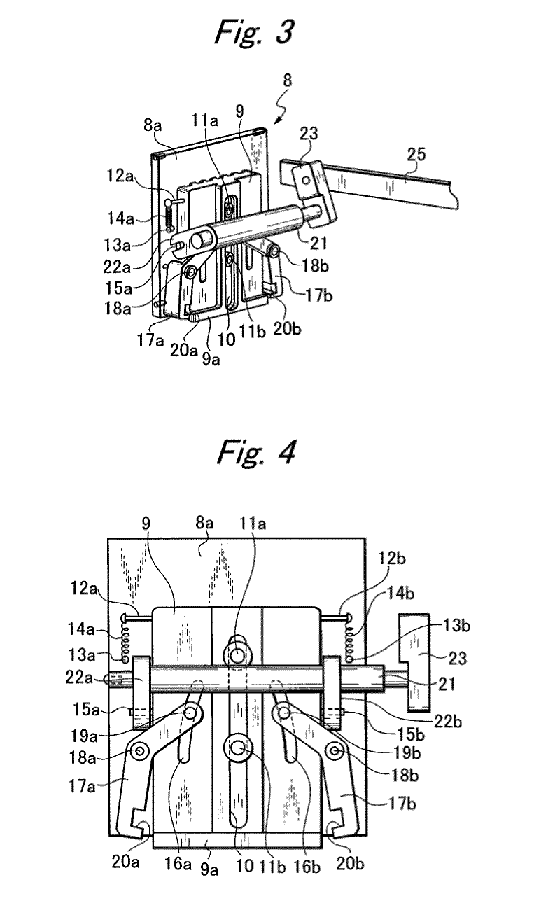

When the functional tag applicator 1 is not in use, i.e., when no force is applied to the control handle 3b, the sliding member 9 of the tag support mechanism 8 is pulled by the coil springs 14a and 14b and held at the lower end as shown in FIGS. 3 and 4. The lower ends of the functional tag support members 17a and 17b are urged outward and spread apart

Under this condition, when the grip 3a and control handle 3b are gripped together and the handle 3b is pulled in while aligning the tag support mechanism 8 at the front-end side with a position on a product where the functional tag is attached, the control handle 3b rotates as shown in FIG. 6. The lever member 28 is rotated in the direction of the arrow “a”. The plate-like member 25 is drawn toward the rear end. Concomitantly, the link member 23 is also pulled in. As a result, the shaft member 21 rotates through a given angle.

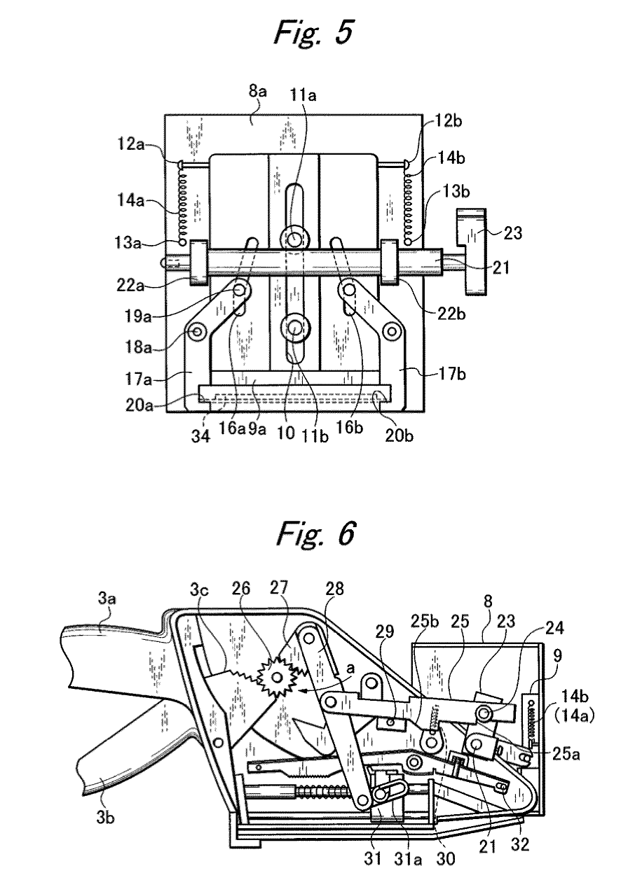

As the shaft member 21 rotates, the arm members 22a and 22b mounted to the shaft member 21 rotate upward. The sliding member 9 is raised to vertical (see FIG. 5) via the bosses 15a and 15b in engagement with the front ends of the arm members. Then, the guide bosses 19a and 19b engaged in the cam grooves 16a and 16b are moved downward along the cam grooves 16a and 16b which are spread apart more widely in going downward. The functional tag support members 17a and 17b rotate about the shafts 18a and 18b and move in the direction to close their lower ends.

In this state, the functional tag support members 17a and 17b are on standby. The control handle 3b continues to be gripped. The lever member 28 is rotated further in the direction of the arrow “a”. The feed-out member 31 is operated via a time-lag member 31a to feed out the tape 5. The tape 5 is folded back at an acute angle around the front end of the peeling member 7 and fed backward. Consequently, one functional tag 34 stuck and held on the tape 5 is peeled off and protrudes ahead of the peeling member 7. As indicated by the dotted line in FIG. 5, both ends of the functional tag 34 are supported in the cutouts 20a and 20b in the functional tag support members 17a and 17b.

The control handle 3b continues to be pulled in unchanged to rotate the lever member 28 for pulling the plate-like member 25 toward the rear end. The tilted member 25b of the plate-like member 25 comes into abutment with the guide pin 29 and becomes pushed up. The cutout 25a is inevitably moved upward out of engagement with the boss 24 of the link member 23. Because the link member 23 disengages from the boss 24 and becomes free, the sliding member 9 pushed upward by the arm members 22a and 22b are forcibly pulled downward by the coil springs 14a and 14b.

Because of this downward pulling, the guide bosses 19a and 19b in engagement with the cam grooves 16a and 16b move along the grooves 16a and 16b in the inward, dosing direction in a manner contrary to the above-described case of raising. 5. Consequently, the lower ends of the functional tag support members 17a and 17b are moved in the opening direction. The functional tag 34 supported in the cutouts 20a and 20b is released. The sliding member 9 descending simultaneously with the releasing strikes and pushes the upper surface of the tag 34. After checking the striking operation, the gripping is loosened to return the control handle 3b to its original position, thus making preparations for the following operations. The pushing performed by striking operation is carried out via the shock-absorbing member 9a as made of rubber as described previously. Therefore, it is unlikely that the functional tag 34 and data recorded therein are damaged.

The gripping of the control handle 3b is loosened to return it to its original position. Thus, the lever member 28 is rotated in the reverse direction, pushing the plate-like member 25 back toward the front end. Consequently, the boss 24 in the link member 23 is again fitted into the cutout 25a. The plate-like member 25 and the shaft member 21 are interconnected via the link member 23. That is, the tag support mechanism 8 assumes the state shown in FIGS. 3 and 4.

As mentioned above, the grip 3a and control handle 3b of the functional tag applicator 1 according to the present invention are gripped strongly and then released. During this one sequence of operations, the tape 5 is fed out from the standby tag support mechanism 8. A new functional tag 34 is peeled off and supplied to the functional tag support members 17a and 17b that are on standby. The supplied functional tag 34 is placed into a position where the tag should be stuck. Then, the support members are pushed against the tag. Thus, a sequence of operations is done.

As described so far, a functional tag support mechanism is provided to permit tape having a functional tag stuck thereon to be used by employing the function of the prior art hand labeler when the functional tag should be stuck on a product. If the size, thickness, or shape of the functional tag is varied, it is possible to accommodate the variation. Hence, the invention shows great utility.

What is claimed is:

1. A functional tag applicator comprising:
a body frame;
a grip integrally formed with the body frame;
a control handle mounted in an opposite relation to the grip;
a feed-out mechanism for feeding out tape in response to an operation of the control handle;
a sensitive pawl for sensing a front end of a functional tag stuck and held on the tape;
a peeling member for peeling off the functional tag from the tape; and
a tag support mechanism for supporting the peeled functional tag;
wherein said tag support mechanism has a sliding member sliding in an up-and-down direction in response to an operation of the control handle and left and right functional tag support members of a pair that are opened and dosed in response to vertical motion of the sliding member, each of the tag support members having a support portion at its lower end, the support portions of the tag support members acting to support the functional tag;
wherein the functional tag peeled off by the peeling member from the tape fed out by the operation of the control handle is supplied to the support portions of the functional tag support members; and
wherein downward motion of the sliding member spreads apart the functional tag support members to thereby release the supplied functional tag and then pressure is applied on the upper surface of the functional tag.

2. A functional tag applicator according to claim 1,
wherein said support mechanism is surrounded by a boxlike outer wall having at least a front-end wall and both sidewalls and having a rear end and a lower end that are open,
the front-end wall has a pair of upper and lower guide pins protruding from an inner side surface of the front-end wall, and
said sliding member is provided with a slit-like guide groove in which the guide pins are slidably fitted, the guide groove extending in an up-and-down direction.

3. A functional tag applicator according to claim 2,
wherein each of said functional tag support members has an intermediate portion pivotally mounted to a shaft protruding from the inner side surface of said front-end wall,
guide bosses protruding toward the front-end wall are formed around upper ends of the functional tag support members,
said sliding member is provided with a pair of cam grooves arranged symmetrically with respect to its center, the cam grooves being spaced from each by a space that increases in going downward, and
the guide bosses are slidably fitted in the cam grooves.

4. A functional tag applicator according to claim 3,
wherein a shaft member is rotatably mounted between the both side walls of said support mechanism and has one end to which the control handle is connected via a link member,
arm members of a pair, each having a slit-like cutout, integrally protrude from a free end of the shaft member,
bosses protrude from both side surfaces of the sliding member and are engaged in the cutouts of the arm members, and
whereby the sliding member is moved up or down by rotating the shaft member through a given angle and, at the same time, the functional tag support members are driven to be opened or dosed via the guide bosses fitted in the cam grooves of the sliding member.

5. A functional tag applicator according to claim 4, wherein said sliding member is always biased downward by coil springs.

6. A functional tag applicator according to claim 5, wherein a shock-absorbing member is mounted at a lower end of said sliding member.

7. A functional tag applicator according to claim 4, wherein the support portions of said functional tag support members are rectangular cutouts.
